(19) United States
(12) Patent Application Publication
(10) Pub. No.: US 2009/0266777 A1
(43) Pub. Date: Oct. 29, 2009

(54) Collapsible adjustable double shooters rack

(76) Inventor: Orin Luvoid Porter, SR., Portland, OR (US)

Correspondence Address: Orin L. Porter, 15168 NW Sweetgale Lane, Portland, OR, 97229, US

(21) Appl. No.: 12/384,735

(22) Filed: Apr. 8, 2009

Related U.S. Application Data
(60) Provisional application No. 61/125,216, filed on Apr. 23, 2008.

(51) Int. Cl. A47F 7/00; G09F 11/00

(52) U.S. Cl. 211/85.7; 40/1

(57) ABSTRACT

My design is a combination of storage and retrieval of different types of sports balls; such as volleyballs, basketballs, and soccer balls. It allows for storage on both the top and bottom of the apparatus and consists of two top and two bottom sections. The top section is angled creating automatic gravity feed for a consistent flow of sports balls. The design is capable of telescoping vertically to adjust to a player's height making for easy access of balls. The design also telescopes inward and outward allowing both a minimum and maximum amount of sports balls to be used and stored. The design is a double and single ball feed system allowing for one or more player to participate in a number of practice drills and may include front and side panels to display advertisement or team logos.

### CROSS REFERENCE TO RELATED APPLICATIONS

This application is a conclusion to application 61/125,216 filed Apr. 23, 2008; the earlier application being a provisional application and this being a non-provisional application for the same invention.

### STATEMENT REGARDING FEDERALLY SPONSORED RESEARCH OR DEVELOPMENT

(NOT APPLICABLE)

### REFERENCE TO SEQUENCE LISTING, A TABLE OR A COMPUTER PROGRAM LISTING COMPACT DISC APPENDIX

(NOT APPLICABLE)

### TECHNICAL FIELD

This invention relates to the general storage of sports balls such as basketballs and volley balls and provides for easy retrieval of sports balls during training, practice and showcasing activities.

### BACKGROUND OF INVENTION

All ball racks have one key element in common; they store sports balls. Most are made of steel or other rigid materials that hold the balls in place. Whether it is a one tier or five tier ball rack system, its sole function is to store sports balls.

Most of these commercial ball racks are movable in some fashion and are capable of being used on several surface types such as indoor and outdoor basketball and volleyball courts. In addition we see commercial ball racks that are stationary or mountable to a wall. You may see these ball racks out on the court during practice and training sessions but they are not being used as an active piece of the training program, instead they serve one purpose; storage. Current ball racks are one dimensional; they lack the ability to dispense balls in a continuous, unaided, fashion and are incapable of adjusting to a player's height.

The lack of versatility we see in commercially available storage racks prevents them from being a useful tool in practice or scrimmage situations. If a player is practicing a particular shot or serve from a certain spot on the basketball court or playing field he or she must bend over to retrieve another ball or chase down the ball they just used. Either the player or coaches have to constantly stop their training to reload the rack which impedes their ability to run fast paced drills such as the catch and shoot.

Current ball racks don't provide height adjustability nor are they capable of telescoping in and out which gives additional room for storage of balls during active drills. In addition they don't give a player or coach the ability to set up a shooting or serving drill in which the player doesn't have to bend over to pick up the ball.

### SUMMARY

The following describes an apparatus used for consistent positional retrieval of sports balls. The invention is a combination of sports ball storage rack and gravity feed ball retrieval, with horizontal and vertical telescoping. The features of this design allow for use in practice, drills, games or personal use.

Basketball players can adjust the height of the invention so that at no time during training would they have to bend over to retrieve a basketball from the apparatus. The length of the apparatus can also be adjusted to fit a number of sports balls allowing the athlete to participate in repetitive, fast paced drills. Volleyball players can practice a number of serves in the same manner. In addition, the invention gives coaches the ability to simultaneously monitor and train two or more players.

The upper portion of the invention is designed with an elevated angle that creates gravity pull; this causes the balls to roll down unaided towards the shooter(s). Once they have removed a sports ball another automatically moves forward and is ready for that player, or the players that follow, to take their turn.

The device's double ball dispensers give several players the ability to practice shots from either side of the invention at the same time. This changes the shooters perspective when they rotate from one side of the invention to the other and adds another dimension to their training.

The under carriage of the invention also allows for storage of sports balls. When sports balls on the upper portion of the invention have been used, players can reload from the bottom tier and continue their training.

The front, top and bottom portions of the invention are designed to move in and out of the back, top and bottom portions of the invention. The top front and top back portion of the invention move horizontally along the arms of the bottom portion of the invention. This telescoping feature allows the invention to be collapsed so that it can be easily stored in any storage area or stored in back of an SUV or other similar automobile for transport to another location.

The invention can also be designed with one feeder track instead of two making it a more useful tool for smaller facilities or private use.

The entire apparatus sits on 4 casters. The casters have scratch resistant wheels, designed for indoor or outdoor use. Each wheel has a weight capacity of 250 lbs.

The invention can be designed with a front plate, made of fiber glass, metal or similar material, in order to display team logos or any desired artwork. The all around sturdy design includes a bottom storage area that can be designed with side platings, allowing for additional placement of team logos or advertisement.

The collapsible double adjustable shooters rack is designed for continuous positional ball retrieval. It adds another dimension to practice and training for individuals and teams and provides a feasible, safe and economical method for storage of sports balls.

### BRIEF DESCRIPTION OF THE DRAWINGS

The detailed description is explained with reference to the following accompanying figures.

FIG. 1 shows a top view of the apparatus and how it fits together and breaks down for storage.

FIG. 2 shows a side view of the apparatus with optional side panel and lower ball storage

FIG. 3 shows a front view of the apparatus with optional front panel.

FIG. 4 shows a back view of the apparatus.

FIG. 5 shows a top view of the ball storage area.

FIG. 6 shows a top view of the apparatus at its most extended point.

FIG. 7 shows a top view of the non extended apparatus.

### DETAILED DESCRIPTION

Described herein is a double ball rack storage and retrieval system that provides height adjustability and vertical telescoping to allow for a minimum and maximum number of sports balls to be stored and used for individualized or group training in sports such as volleyball and basketball.

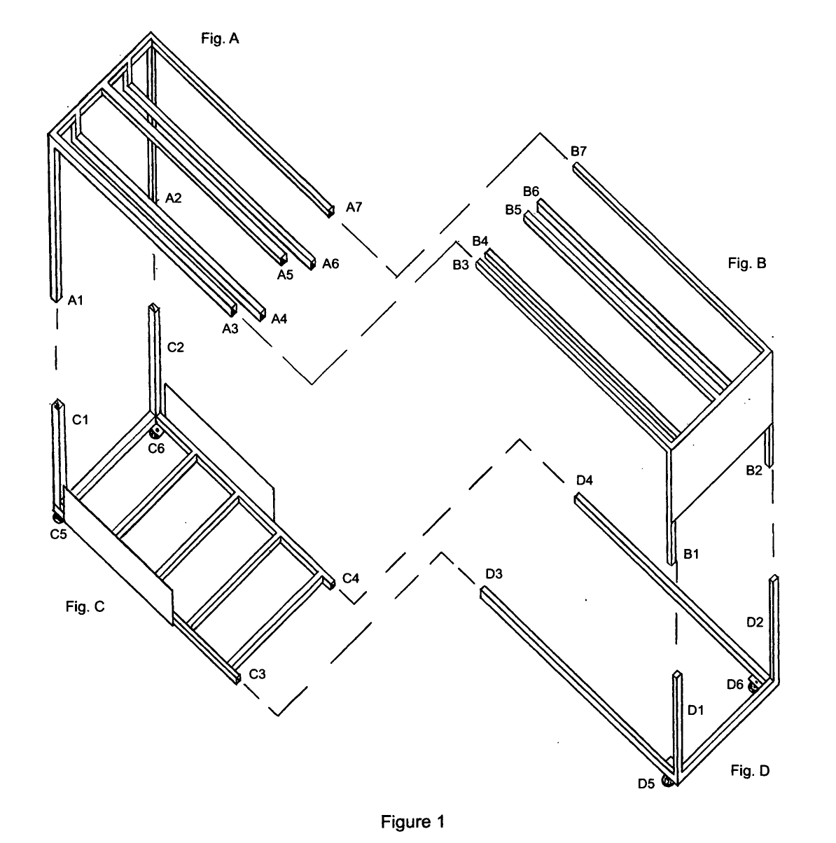

FIG. 1 shows how apparatus fits together and breaks down for storage. The frame consists of four sections: Two upper sections labeled FIG. A and FIG. B and two bottom sections labeled FIG. C and FIG. D.

FIG. A has five horizontal tracks, labeled A3, A4, A5, A6, and A7, which are inserted onto the 5 corresponding horizontal tracks of FIG. B, labeled B3, B4, B5, B6, and B7.

FIG. C shows horizontal tracks, C3 and C4, which are inserted onto the horizontal tracks, D3 and D4, of FIG. D. This connection allows the apparatus to extend horizontally for a maximum or minimum of sports balls.

FIG. A shows vertical extensions, A1 and A2, which are inserted onto vertical extensions, C1 and C2 allowing for vertical adjustment.

FIG. B shows vertical extensions, B1 and B2 that are inserted onto vertical extensions, D1 and D2 to allow for vertical adjustment. Once FIG. A and FIG. B are joined together they form the top portion of the apparatus.

Likewise once FIG. C and FIG. D are joined together they form the bottom portion of the apparatus. The legs of the top section are then lowered onto the legs of the bottom section forming an apparatus for sports ball retrieval.

When all four sections of the apparatus are together they form four legs that are supported by wheels (FIG. C5, C6 and FIG. D5, D6).

FIG. A & C and FIG. B & D slide vertically to allow the apparatus to be adjusted to accommodate the various heights of users; apparatus is then held in place at desired level by a locking system such as cater pins.

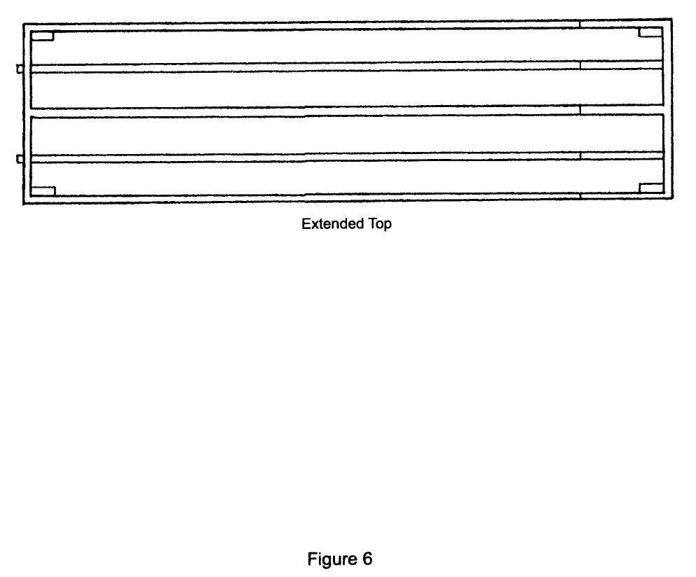

FIG. B and FIG. D form the front portion of the apparatus. FIG. A and FIG. C form the back portion of the apparatus. Pulling FIG. A and FIG. B apart allows the apparatus to telescope, extending in and out to hold the desired number of sports balls on its upper tracks. (See FIG. 6 which shows the fully extended top of apparatus for ball retrieval).

The legs of FIG. A (FIG. A1 and A2) are longer than the legs of FIG. B (FIG. B1 and B2). This creates a sloped track which in turn produces the desired “gravity feed”, allowing for sports balls to roll from FIG. A towards FIG. B whenever a sports ball is removed from the front of FIG. B.

Vertical and horizontal telescoping allows the apparatus to collapse for easy storage and travel thereby eliminating the need to dismantle the ball rack; however the apparatus can be easily taken apart into the four sections described in FIG. 1 if so desired.

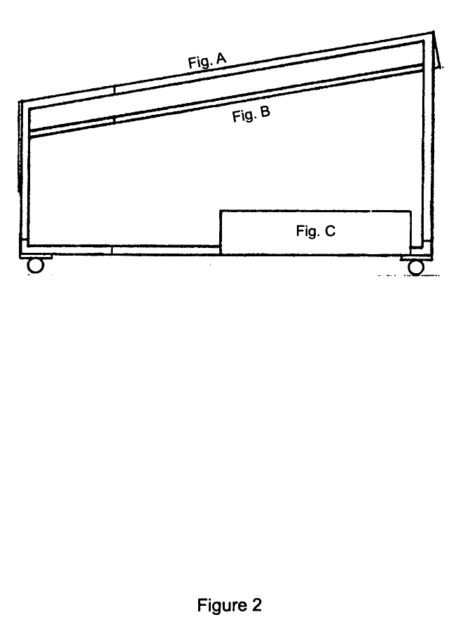

FIG. 2 shows a side view of the apparatus with lower side panel (FIG. C). The side panel may be used for additional display of logo as well as to further support sports balls on lower storage portion of ball rack. This side view also shows the uninhibited and sturdy side rails (FIG. A & FIG. B) which can be used to hang displays such as advertisements or logos.

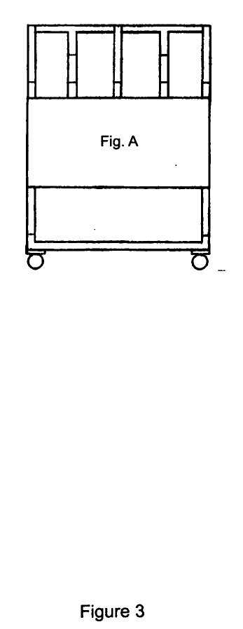

FIG. 3 shows the front portion of the apparatus, including front plating (FIG. A) where a team logo can be displayed.

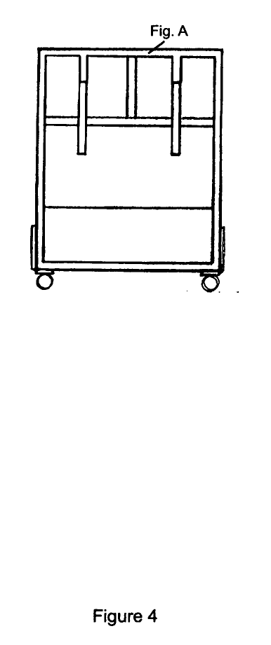

FIG. 4 shows the back portion of the apparatus where team logo or advertisement can also be displayed by attaching across retrieval tracks (FIG. A).

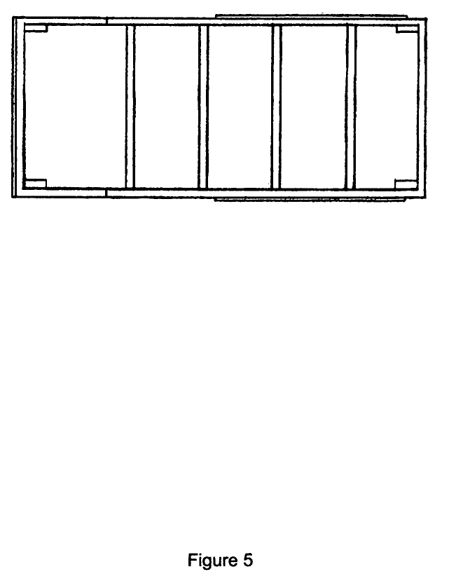

FIG. 5 shows the lower ball storage area where several balls can be stored. The capacity of the lower storage area remains the same regardless of the extension length of the apparatus.

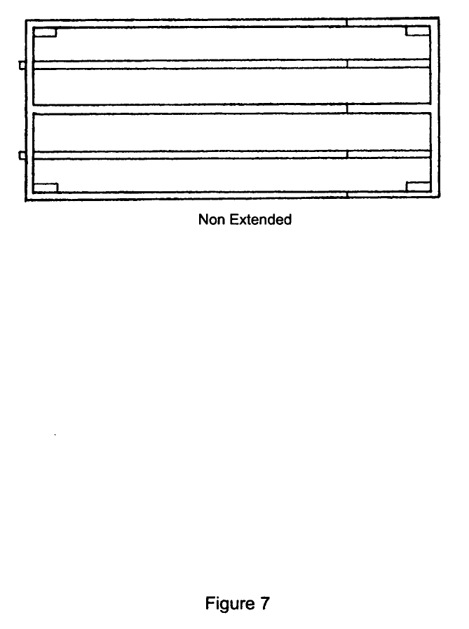

FIG. 6 and FIG. 7 both show a top view of the apparatus at its most horizontally extended and non-extended points.

The apparatus can be welded, hinged or screwed together for stability.

The embodiments described herein are to be considered in all respects only as exemplary and not restrictive. The scope of the invention is, therefore, indicated by the subjoined Claims rather than by the foregoing description.

What is claimed is:

1. An apparatus that provides for fluid movement of sports balls due to its unique angled design, comprising of; a frame having at least one vertical support member, the frame configured with an upper and lower portion, both capable of holding a number of sport balls; the upper and lower portions also capable of extending both vertically and horizontally; the upper portion slanted at an angle that allows unaided movement of the sport ball down the upper track in a continuous fashion for retrieval of the sport ball by a individual; the lower portion designed to hold a additional sports balls.

2. The apparatus of claim 1, wherein the sport ball is a basketball or volleyball.

3. The apparatus of claim 1, wherein the rear extendable legs attached to the upper portion are longer than the front legs making a sloping track and creating a gravitational feed that allows for a sports ball to move unaided from the rear end of the apparatus to the front.

4. The apparatus of claim 1, wherein when the desired number of balls are placed in the upper portion of the apparatus, and a ball is removed from the front of the apparatus another ball moves freely and unaided to the front position and so forth in a continuous manner.

5. The apparatus of claim 1, wherein the upper and lower portions are structured to provide both height adjustability and horizontal extension via extendable tracks and legs.

6. The apparatus of claim 1, wherein the horizontal tracks may be extended in and out to hold the desired number of sports balls and the legs adjust vertically to allow for players of various heights to set the apparatus to a specific height.

7. The apparatus of claim 1, wherein the upper and lower portions further allow for complete vertical and horizontal extension, making for simple disablement of apparatus, if needed or desired, for transportation or storage.

8. A novel storage and retrieval rack; comprising of; a mobile frame configured with an upper portion to hold a maximum or minimum number of sports balls, volleyballs or basketballs; the upper portion slanted at an angle to facilitate forward movement of sports balls, with the upper portion connected to a lower portion capable of storing additional sports balls.

9. The apparatus of claim 9, wherein the frame includes a front panel to display a logo or advertisement.

10. The apparatus of claim 9, wherein the frame is configured in such a manner that allows for easy placement of additional signage or advertisement on both the sides and rear of apparatus.

11. The apparatus of claim 9, wherein the frame is designed with wheels attached, for easy transportation.

12. The apparatus of claim 9, wherein the frame design allows two players the ability to use the apparatus simultaneously.
